(19) United States
(12) Patent Application Publication
(10) Pub. No.: US 2016/0028767 A1
(43) Pub. Date: Jan. 28, 2016

(54) Method for Preventing Information Leaks on the Stack Smashing Protector Technique

(71) Applicants: Jose Ismael Ripoll, Valencia (ES); Hector Marco, Valencia (ES)

(72) Inventors: Jose Ismael Ripoll, Valencia (ES); Hector Marco, Valencia (ES)

(21) Appl. No.: 14/341,118

(22) Filed: Jul. 25, 2014

(51) Int. Cl. H04L 29/06; G06F 21/62; G06F 9/45; H04L 29/08

(52) U.S. Cl. CPC H04L 63/1466; H04L 67/10; G06F 21/6218; G06F 8/41

(57) ABSTRACT

A method for hardening the Stack-Smashing Protector (SSP) technique which prevents information leaking of the protecting guard is disclosed. The reference stack guard secret value is renewed at one or more selected time points during the execution of the application. The technique is non-intrusive and has a negligible run-time cost (both spatial and temporal). The technique reuses the SSP infrastructure, and does not need to recompile the code or modify the binary image of the application. The method prevents any kind of brute force attacks against the SSP technique and most memory leaks affecting the canary guard.

### PRIOR DISCLOSURES

The embodiments of the present invention claims the benefit of the partially disclosure invention done by the authors in the IEEE International Symposium on Network Computing and Applications (NCA), 2013 12th, pages 243-250, 22 Aug. 2013, Boston, EEUU.

### FIELD OF THE INVENTION

The present invention relates, in general, to electrical computers and digital processing systems pertaining to processing architectures and instruction processing and, in particular, to a stack based buffer-overflow-type security attacks.

### BACKGROUND

A decade ago, buffer overflows, specially stack smashing, was the most dangerous threat to computer system security. Over the last years, several techniques have been developed to mitigate the ability to exploit this kind of programming faults. Stack Smashing Protector (SSP), Address Space Layout Randomization (ASLR) and non-executable (NX) are widely used in most systems due to its low overhead, sim-plicity and effectiveness.

Following the classic measure/counter-measure sequence, a few years after the introduction of each protection technique, a method to bypass or reduce its effectiveness was published. The SSP can be bypassed using brute force attacks or by overwriting non-shielded memory; the ASLR can be bypassed using brute force; and the NX, which effectively blocks the execution of injected code, can be bypassed using ROP (Return Oriented Programming). In spite of the existing counter-measures, those techniques are still effective protection methods, in some cases they are the only barrier against attacks until the software is upgraded to remove the vulnerability.

Unfortunately, the forked and pre-forked networking server architectures are specially prone to brute force attacks. All the children processes inherit/share the same memory layout and the same canary as the parent process. The attacker can try in bounded time all the possible values of the canary (for SSP) and memory layouts (for ASLR) until the correct ones are found. There is a very dangerous form of attack to the SSP, called byte-for-byte, where the attacker tries each byte of the canary independently, which permits to find out the value of the canary with just a few hundreds of trials, as a result, a system can be defeated in a few seconds.

Another area where the standard SSP technique is not as effective as orig-inally designed is the software architecture where a single (the launcher) process prepares the execution environment of the children applications by pre-linking, pre-loading and setting up the run-time environment. This architecture is typically used to speed-up the launch time and to reduce resource usage. The canary value of the SSP (the secret) is inherited by all the children processes, and so, all the children share the same secret. An information leak, accidental or intentional, on any of the children may compromise the security of other children or even the base system.

For the sake of clarity, we will assume that the stack grows downwards, i.e. from higher to lower addresses, but the invention also applies to systems which implement upward growing stacks, or any other form of protecting the sensitive data on the stack from vector (or other data) overflow; as for example, but not limited to, the stack protection technique disclosed in U.S. patent application Ser. No. 13/772,858.

The value of the canary is a random value computed during the process initialization. In order to bypass the SSP protection, the attacker must know the current canary value for building the exploit. As far as the value is kept secret, the attack will be prevented by the SSP. In some implementations, the canary value is a word with all bytes random except one, that is zeroed. The zero byte is used to prevent the possibility to exploit the error caused by incorrect string handling. Our invention is not limited by the way the random value is computed.

Since the value of the canary is not a constant but a random value chosen when the program starts, this value, called reference-canary, has to be stored somewhere in the program memory or in a dedicated processor register if available. For example, in ×86-32 and ×86-64 architectures the reference-canary is stored in a special data segment which is not accessible as a normal variable and can not be easily overwritten or read abusing data structures.

### Known Patent Documents

U.S. Pat. No. 6,941,473 B2, entitled “Memory device, stack protection system, computer system, compiler, stack protection method, storage medium and program transmis-sion apparatus”, discloses a method of using a guard value, or canary, to protect both the return address and the previous-frame-pointer from the local function buffers. This patent is an extension or adaptation of the work presented by “Automatic Detection And Prevention Of Buffer Overflow Attacks”, Crispin CoWan, Calton Pu, David Majer, Heather Hinton, Peat Bakke, Steve Beattie, Aaron Grier, Perry Wagle, and Quan Zhang the 7th USENIX Security Symposium, San Antonio, Tex., January 1998, to protect also the previous-frame-pointer. This innovation has been later been refined by the ProPolice strategy which arranges the content of the stack to avoid local scalar variables to be overwritten by local buffers. None of those improvements address the problem of canary value leaks, which is the novelty of the present disclosure. U.S. Pat. No. 6,941,473 B2 is hereby incorporated by reference into the specification of the present invention.

U.S. Pat. No. 6,578,094 B1, entitled “Method for preventing buffer overflow attacks”, discloses a method of having a called procedure determine an upper bound that may be written to a stack allocated array/buffer without overwriting the stack-defined data. Before data is written to the stack, the upper bound is checked, which thereby prevents overwriting data. The present method does not check for an upper bound before writing data to a stack. U.S. Pat. No. 6,578,094 B1 is hereby incorporated by reference into the specification of the present invention.

U.S. Pat. No. 7,581,089 B1, entitled “Method of protecting a computer stack”, discloses a method of having two stacks, the normal stack and a second one where the return addresses are copied to. Both stacks are automatically compared and re-synchronized at each return. The present method does not use a secondary stack and the return address is not checked or validated. U.S. Pat. No. 7,581,089 B1 is hereby incorporated by reference into the specification of the present invention.

U.S. Pat. No. 7,660,985 B2, entitled “Program security through stack segregation”, discloses a method of having two stacks: a normal stack, which grows downward, and an inverse stack, which grows upward. Items on the stack data structure are segregated into protected (frame pointers and return addresses) and unprotected classes (function parameters and local variables). The present method use a single stack and also does not modify the layout of the stack. U.S. Pat. No. 7,660,985 B2 is hereby incorporated by reference into the specification of the present invention.

U.S. Pat. No. 7,086,088 B2, entitled “Preventing stack buffer overflow attacks”, discloses a method and system for preventing stack buffer overflow attacks by encrypting return addresses prior to pushing them onto the runtime stack. When an encrypted return address is popped off the runtime stack, the computer system decrypts the encrypted return address to determine the actual return address. The present invention does not alter the return address. U.S. Pat. No. 7,086,088 B2 is hereby incorporated by reference into the specification of the present invention.

U.S. Pat. No. 8,631,248 B2, entitled “Pointguard: method and system for protecting programs against pointer corruption attacks”, discloses a method for protecting against pointer corruption by encrypting a pointer. The encrypted pointer is decrypted before the pointer is used. The present invention is not directed toward encrypting pointers. U.S. Pat. No. 8,631,248 B2 is hereby incorporated by reference into the specification of the present invention.

Both, U.S. Pat. No. 7,467,272 B2, entitled “Write protection of subroutine return addresses”, and U.S. Pat. No. 8,028,341 B2, entitled “Providing extended memory protection” discloses two methods of moving return addresses to the processor and providing a method of write protecting the return addresses to make them non-accessible. Both methods require the modification of the processor, or the memory management unit (MMU), so that the execution platform has the capability to lock (write protect) very small blocks of memory. The present method can be used with existing hardware. Both, U.S. Pat. No. 7,467,272 B2 and U.S. Pat. No. 8,028,341 B2 are hereby incorporated by reference into the specification of the present invention.

CN 1294468 C, entitled “Dynamic stacking memory management method for preventing buffering area from overflow attacking” discloses a method for preventing stack buffer overflows by dynamically adding a random number of padding bytes between the stack buffers and the return address. So that an attacker can not accurately determine the location of the return address. The present invention does not modify the layout of the stack, and so it can be used transparently on current systems. CN 1294468 C is hereby incorporated by reference into the specification of the present invention.

### Known Patent Application Documents

Patent application US 2013/0219373 A1, entitled “Stack overflow protection device, method, and related compiler and computing device”, discloses a method of splitting the code of at least one function into code which contains string manipulation (which is supposed to be prone to buffer overflows) and code without that behavior. The stack protector guard is used only in the region with the string operation, which is a clever way to reduce the overhead on the stack protector technique, but it does not prevent against guard leaks. Patent application US 2013/0219373 A1 is hereby incorporated by reference into the specification of the present invention.

Patent application US 2004/0168078 A1, entitled “Apparatus, system and method for protecting function return address”, discloses a method of protecting against stack overflow by storing the return address and the stack pointer in a separate stack. The return address is evaluated before executing the return to check if it is a valid return address. No read or write function is permitted to the separate stack, thereby making this second stack secure. The method of US 2004/0168078 A1 guards against stack overwrite, which requires extra memory space to backup sensitive information (return address and stack pointer). Patent application US 2004/0168078 A1 is hereby incorporated by reference into the specification of the present invention.

### SUMMARY OF THE INVENTION

The goal of the present invention is to overcome the deficiencies of the prior art on Stack Smashing Protection (SSP) techniques.

When the existing SSP techniques are employed on applications where multiple processes share (inherit) the same canary value, the secrecy of the canary may be treated by the dissemination of the secret canary among multiple processes. A fault or information leak on any of the process that share the same canary value may compromise the security of the whole system.

The present invention is applicable, but not limited to, networking applications where several processes are used to attend client requests (forking and pre-forking architectures), and also execution platforms where the client applications are launched from a father process which pre-loads libraries and prepares the execution environment of the children. One of ordinary skill in the art will know other types of execution frameworks where the same canary value is also shared among different execution entities.

The present invention is also applicable to a single process against potential canary value leaks, by making the leaked canary value useless.

The present invention is effective against canary leaks. For example but not limited to them: all forms of brute force attacks against the canary, direct information leaks, format string vulnerabilities, improper memory dumps or malicious code that intentionally reveals the canary value.

The present invention identifies, in some embodiments, the functions that are relevant for protecting the secrecy of the canary value; and how to effectively change the value of the canary on those said functions such that the potentially stolen information is useless to the attackers.

Although the present invention is directly related to the SSP technique, when the disclosed invention is used in combination with the other commonly used protection techniques, as Address Space Layout Randomization (ASLR) and Non-eXecutable data (NX), it greatly increases by several orders of magnitude the diffi-culty of building a successful brute force attack.

The present invention is an advancement in the art of protecting applications from stack buffer overflow attacks with the following properties:
It relies on the existing SSP infrastructure.
It provides an effective protection mechanism against canary value leaks. In particular, it is no longer possible to perform any kind of brute force attacks.
Preserves backward compatibility because the layout and content of the stack is not modified.
It can be used on most applications requiring neither to modify nor to recompile the application code.
It does not use extra memory space in most cases or only a few computer words, in rare cases.
It provides a solution that does not disrupt debuggers used in software development cycles.
The overhead introduced by the present invention is negligible.

### BRIEF DESCRIPTION OF THE DRAWINGS

The example embodiments of the present disclosure will be described in greater detail in conjunction with the accompanying drawings. The features and advantages of the present disclosure will become more apparent, wherein, in the exemplary embodiments of the present disclosure, same reference numbers generally represent same components.

FIG. 1 shows a detailed example of a stack diagram.

FIG. 2 represents the same stack than that of FIG. 1, in a simplified form. The rest of the figures use the simplified form of the stack.

FIG. 3 shows a stack and a reference-canary before it is renewed.

FIG. 4 shows the stack of FIG. 3 when the reference-canary is renewed.

FIG. 5 shows the stack of FIG. 4 after a new stack frame is created.

FIG. 6 shows an example of the content and behavior of the stack when the reference-canary is changed on type 1 functions.

FIG. 7 shows an example of the content and behavior of the stack when the reference-canary is changed on type 2 functions.

FIG. 8 shows an example of the content and behavior of the stack when the reference-canary is changed on type 3 functions.

FIG. 9 shows an example of the content and behavior of the stack when the reference-canary is changed on type 4 functions.

FIG. 10 shows an example of the content and behavior of the stack when the reference-canary is changed on type 5 functions.

FIG. 11 shows an example of the content and behavior of the stack when the reference-canary is changed on type 6 functions.

### DETAILED DESCRIPTION OF THE INVENTION

In order to easily understand the operation of the disclosed invention, the following general observations from previous art shall be considered:
Most applications, specially networking servers, after a fork operation, the child process executes a different flow of code, which ends with an explicit call to the exit system call. That is, the child process does not return from the function that started the child code.
Each child process of a network server defines an error confinement region. That is, any error that occurs on a child process does not affect the correct operation of the father or other sibling processes, as far as the temporal and spatial isolation is honored.
Although there are several variants of the SSP technique, most implementations use a single reference-canary 100 per process, which is saved in a protected area and initialized during the process start up.
The reference-canary 100 is copied in the stack frame 101 between the return address and the buffers, which is called frame-canary 103. Depending on some compilation optimizations not all stack frames are protected with a frame-canary.
Some SSP variants may implement slightly different versions of the basic mechanism, which does not invalidate the applicability of the disclosed invention.
The stack integrity (compare the reference-canary 100 with the frame-canary 103) is only done at the end of each function, or block of code, right before the returning instruction or leaving the block of code.
Only the value of the frame-canary of the current stack frame is compared with the reference-canary.

The present invention consists in renewing the value of the reference-canary of the process at selected functions, or block of code during the execution of the process. There is only one single reference-canary for each process. Our invention does not use a secondary stack to hold copies of the frame-canaries, and relies on the same infrastructure of the SSP method.

Typically, there is at most one vulnerable function or vulnerable block of code per process. It is quite odd to have multiple buffer overflow exploitation functions on the same process. Therefore, from the point of view of the attacker there is only one frame-canary to defeat, which is the frame-canary of the vulnerable function. And so, there is little benefit on randomizing the canary on all the functions but on the vulnerable one.

There are some special functions where the reference-canary can be renewed and not restored, and the program can continue its execution normally. An example of this type of functions, but not limited to it, is the code executed by the child processes right after its creation (for example, fork and clone), which matches the concept of error confinement region. For example, each client request is attended by a child process of a networking server when it is configured as a forking server.

More generally, it is possible to renew the value of the reference-canary at any time during the execution of a program, as far as the reference-canary is restored to its previous value before the stacks frames holding old canaries values are checked.

In what follows, the term “function” and the term “stack-frame” are used interchangeably. The former is an active element, and the later is the passive data structure which support the function execution. Depending on the context where the term is used, it is more natural to use one or the other, but in both cases it refers to the same concept.

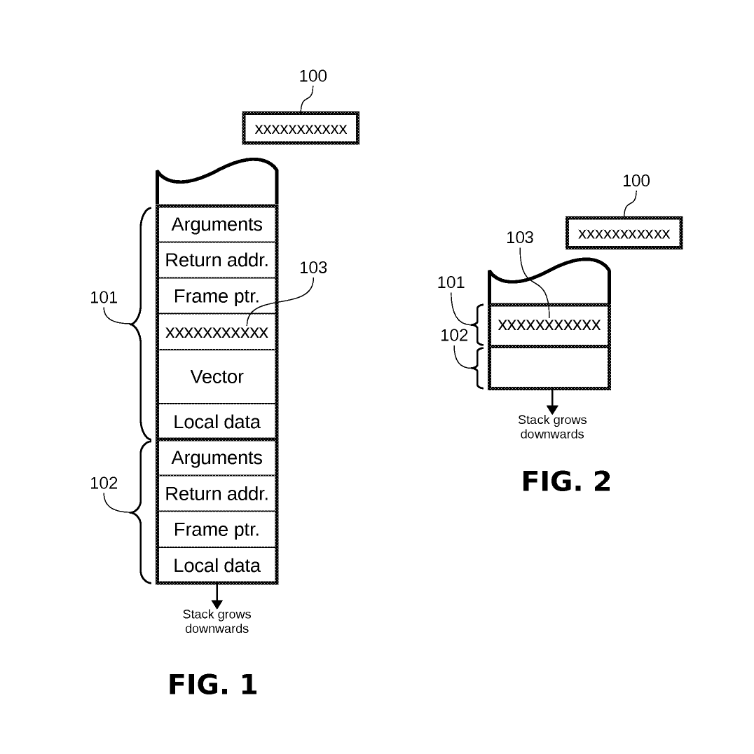

FIG. 1 and FIG. 2 sketch the content of a typical stack in two different forms: detailed stack (FIG. 1) and simplified stack (FIG. 2). FIG. 1 shows a stack with two frames 101, 102 filled with some example content on each one: Arguments, Return addr., Frame Ptr., etc. The frame 101 has a frame-canary value 103 and the frame 102 does not contain a frame-canary. The present invention only depends on the value of the reference-canary 100 and the frame-canary 103. FIG. 2 shows the same stack as FIG. 1 with two frames 101, 102, but only the frame-canary 103 is displayed, the rest of the content is not shown. Those of skill in the art will appreciate our invention can be used with other stack frame contents and layouts.

In the rest of this document, we will use the simplified stack representation.

Our invention does not impose any restriction on which stack frames shall be protected by a canary, and which ones shall not be protected. Our invention is independent of the exact implementation of the SSP, and can be used with any variant of the SSP.

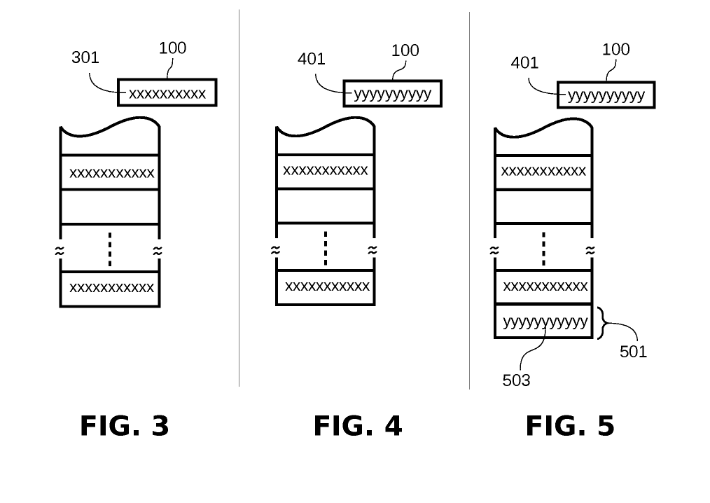

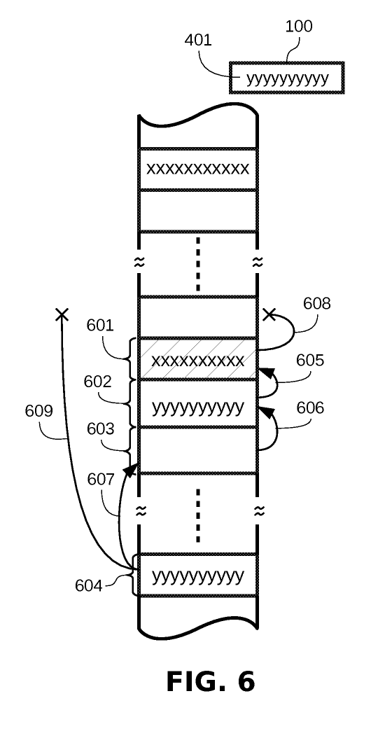

Referring to FIG. 3, FIG. 4 and FIG. 5; they represent the state of the stack at three different instants upon renewing the reference-canary. FIG. 3 represents the stack and the reference-canary 100 and its value 301 before the reference-canary is renewed. FIG. 4 represents the stack and the reference-canary 100 right after its value has been renewed 401 (from the value 301 to the new one 401). FIG. 5 represents the state of the stack after a new frame 501 is created using the renewed reference-canary. The frame-canary value 503 of the new frame 501 uses the renewed reference-canary value 401.

FIG. 6 to FIG. 11, represent the content of the stack for six different type of functions. The stack frames of the functions where the reference-canary 100 is renewed are marked as dashed boxes 601, 701, 801, 901, 1001 and 1101. All figures represent the state of the stack after the reference-canary 100 has been renewed. Therefore, the frame-canary of the functions previous to the dashed as well as the dashed one contain the old canary value 301 if any, and posterior frame-canaries have the renewed value 401 if any.

Referring to FIG. 6; it represents the content of the stack when a non-returning function, the dashed stack frame 601, has called some nested functions 602 to 604. Each nested stack frame may (602, 604) or may not (603) have a frame-canary. During the execution of the non-returning function 601, called type 1 function, the reference-canary 100 can be renewed. The frame-canary value of the following functions (the said nested ones 602, 604) will be the new reference-canary value 401. The said nested functions can make normal returns with 605 or without 606 SSP canary value check. They are also allowed to make non-local-jumps 607 to functions within the nested region. A type 1 function must not return to the parent caller 608. And neither type 1 nor its nested functions 602 to 604 can make non-local-jumps 609 to any parent function of the said type 1 function.

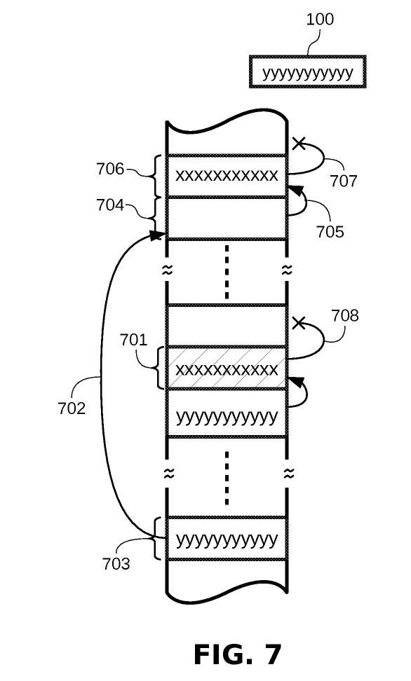

Referring to FIG. 7; it shows the representation of how our finding is used on type 2 functions. A type 2 function 701 does not return 708 but it is allowed to make non-local-jumps 702 from itself 701 or from a nested function 703 to a parent function of the said type 2 function. The destination function of the non-local-jump 702 can be any function 704 which none of its return-reachable 705 functions check the frame-canary value. Therefore, the functions that check the old frame-canary 701, 706 must not return 708, 707.

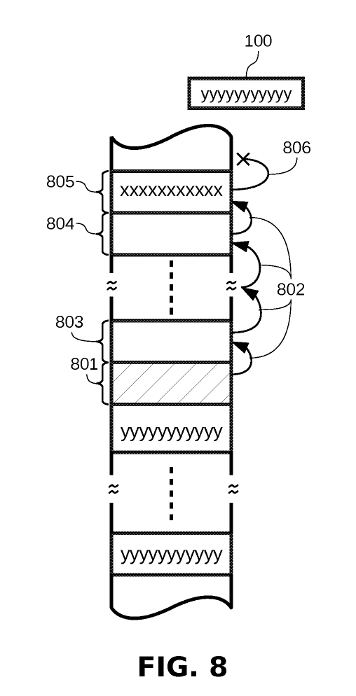

Referring to FIG. 8; it shows the representation of how our finding is used on type 3 functions. A type 3 function 801 may return 802 but does not check the frame-canary integrity neither itself 801 nor on any return-reachable parent functions 803, 804. Parent functions which check the frame-canary 805 can not return 806.

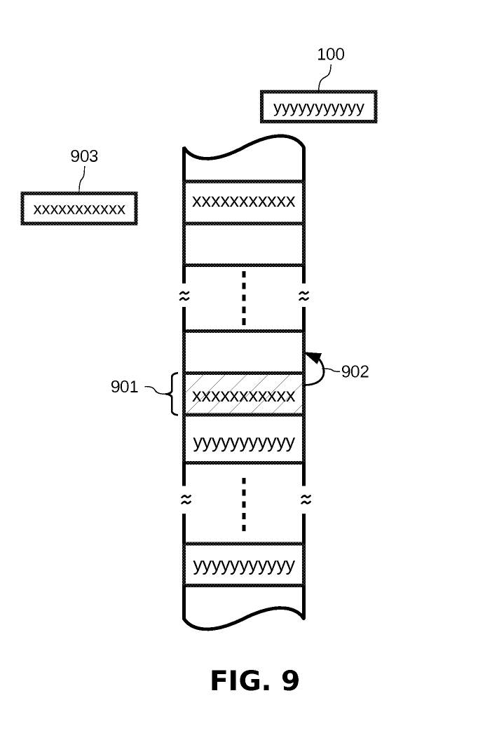

Referring to FIG. 9; it shows the representation of how our finding is used on type 4 functions. A type 4 function 901 renews the reference-canary 100 and eventually returns 902 checking the frame-canary. A type 4 function shall save the original value of the reference-canary 301 in a designated location 903 and restore it back (copy the old value from the saved reference-canary 903 in the reference-canary 100) before the current frame-canary is checked 902. The original reference-canary value must be saved by the said type 4 function or any of its parent functions.

The saved reference-canary is represented as a global variable 903 for clarity, but it is not limited to it. The saved reference-canary may be saved as a local variable or on a dedicated memory segment or on a processor register or at any other retrievable location.

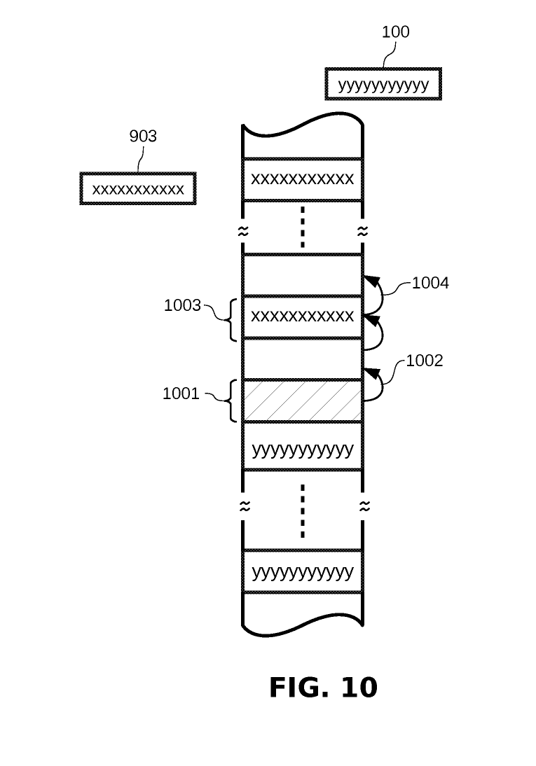

Referring to FIG. 10; it shows the representation of how our finding is used on type 5 functions. A type 5 function 1001 renews the reference-canary and eventually returns 1002. The stack check is not done by the type 5 function, but there are at least one parent function 1003 which checks the integrity of its stack 1004. The parent function 1003 which checks the stack integrity 1004 shall restore the reference-canary to the original value, by copying the old value from the saved reference-canary 903 in the reference-canary 100. In order to be able to restore the reference-canary, it has had to be saved, in a designated location 903, before it is renewed. The original reference-canary value must be restored by the said type 5 function or any of its parent functions up to the function 1003 which checks the frame-canary.

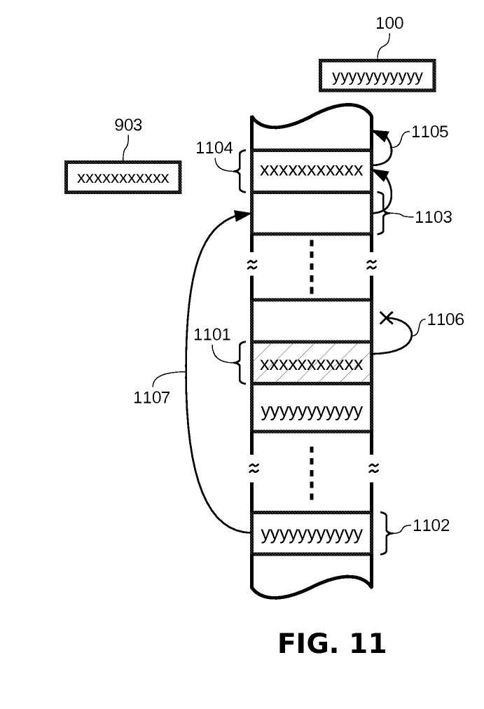

Referring to FIG. 11; it shows the representation of how our finding is used on type 6 functions. A type 6 function 1101 does not return to its caller 1106, but makes a non-local-jump 1107 from itself 1101 or from a nested function 1102 to a parent function 1103, which the said parent function 1103 or a previous caller function 1104 checks the integrity of its stack 1105. Then, the value of the reference-canary 100 has to be saved, in a designated location 903, before renewing it at the type 6 function 1101, and restored it back before returning from the function 1104 that checks the frame-canary.

### LIST OF REFERENCES CITED

List of Patents

| | | Publication | | |
|---|---|---|---|---|
| Cited Patent | Filing date | date | Applicant | Title |
| CN 1294468 C | Apr. 9, 2004 | Jan. 10, 2007 | [symbol] | Dynamic stacking memory management |
| | | | | method for preventing buffering area from |
| | | | | overflow attacking |
| U.S. Pat. No. 6,578,094 B1 | Mar. 2, 2000 | Jun. 10, 2003 | International Business | Method for preventing buffer overflow attacks |
| | | | Machines Corporation | |
| U.S. Pat. No. 6,941,473 B2 | Jan. 30, 2001 | Sep. 6, 2005 | International Business | Memory device, stack protection system, |
| | | | Machines Corporation | computer system, compiler, stack protection |
| | | | | method, storage medium and program |
| | | | | transmission apparatus |
| U.S. Pat. No. 7,086,088 B2 | May 15, 2002 | Aug. 1, 2006 | Nokia, Inc. | Preventing stack buffer overflow attacks |
| U.S. Pat. No. 7,467,272 B2 | Dec. 16, 2004 | Dec. 16, 2008 | International Business | Write protection of subroutine return addresses |
| | | | Machines Corporation | |
| U.S. Pat. No. 7,581,089 B1 | Apr. 18, 2007 | Aug. 25, 2009 | The United States Of | Method of protecting a computer stack |
| | | | America As Represented By | |
| | | | The Director Of The | |
| | | | National Security Agency | |
| U.S. Pat. No. 7,660,985 B2 | Apr. 29, 2004 | Feb. 9, 2010 | At&T Corp. | Program security through stack segregation |
| U.S. Pat. No. 8,028,341 B2 | Oct. 27, 2009 | Sep. 27, 2011 | Intel Corporation | Providing extended memory protection |
| U.S. Pat. No. 8,631,248 B2 | Oct. 31, 2007 | Jan. 14, 2014 | Apple Inc. | Pointguard: method and system for protecting |
| | | | | programs against pointer corruption attacks |

### LIST OF PATENT APPLICATIONS

| | | Publication | | |
|---|---|---|---|---|
| Cited Patent | Filing date | date | Applicant | Title |
| US 2003/0177328 A1 | Mar. 13, 2003 | Sep. 18, 2003 | FUJITSU LIMITED | Method and apparatus for controlling |
| | | | | stack area in memory space |
| US 2004/0168078 A1 | Dec. 2, 2003 | Aug. 26, 2004 | Brodley Carla E., | Apparatus, system and method for |
| | | | Vijaykumar Terani N., Hilmi | protecting function return address |
| | | | Ozdoganoglu, Kuperman | |
| | | | Benjamin A. | |
| US 2013/0219373 A1 | Feb. 21, 2013 | Aug. 22, 2013 | International Business | Stack overflow protection device, |
| | | | Machines Corporation | method, and related compiler and |
| | | | | computing device |

### LIST OF OTHER REFERENCES

Bulba and Kil3r. Bypassing stackguard and stackshield. Phrack, 56, 2002.
Crispin Cowan, Calton Pu, Dave Maier, Heather Hintongif, Jonathan Walpole, Peat Bakke, Steve Beattie, Aaron Grier, Perry Wagle, and Qian Zhang. Stackguard: Automatic adaptive detection and prevention of buffer-overflow attacks. In Proc. of the 7th USENIX Security Symposium, pages 63-78, January 1998.
H. Etoh. GCC extension for protecting applications from stack-smashing attacks (ProPolice), 2003. URL http://www.trl.ibm.com/projects/security/ssp/.
Aleph One. Smashing the stack for fun and profit. Phrack, 7(49), 1996.
Gerardo Richarte. Four different tricks to bypass stackshield and stackguard protection. World Wide Web, 1, 2002.
Hovav Shacham, Matthew Page, Ben Pfaff, Eu-Jin Goh, Nagendra Modadugu, and Dan Boneh. On the effectiveness of address-space randomization. In Proceedings of the 11th ACM conference on Computer and communications security, CCS '04, pages 298-307, New York, N.Y., USA, 2004. ACM. ISBN 1-58113-961-6. doi: 10.1145/1030083.1030124. URL http://doi.acm.org/10.1145/1030083.1030124.
Minh Tran, Mark Etheridge, Tyler Bletsch, Xuxian Jiang, Vincent Freeh, and Peng Ning. On the expressive-ness of return-into-libc attacks. In Proceedings of the 14th international conference on Recent Advances in Intrusion Detection, RAID'11, pages 121-141, Berlin, Heidelberg, 2011. Springer-Verlag. ISBN 978-3-642-23643-3. doi: 10.1007/978-3-642-23644-0_{—}7. URL http://dx.doi.org/10.1007/978-3-642-23644-0_{—}7.
‘xorl’. Linux GLibC Stack Canary Values, 2010. URL http://xorl.wordpress.com/2010/10/14/linux-glibc-stack-canary-values/.

What is claimed is:

1. A method for protecting the SSP technique on a program against leaking information regarding the value of the canary of the said SSP technique. The method consists on renewing the reference-canary at key places in the code while the program is running. The method comprising the steps of:
a) prior to the compilation, identify a function, or block of code, such that the already stacked frame-canaries are never checked afterwards.
b) for each of said identified function, or block of code, it is possible to renew the reference-canary. Comprising the steps of:
i. compute a new random number,
ii. overwrite the reference-canary with the said new random number.

2. The method of claim 1, wherein:
a) the said identified function, or block of code, does not return and
b) the said identified function, or block of code, does not have nested functions which make non-local-jumps to a parent function of the said identified function, or block of code.

3. The method of claim 1, wherein:
a) the said identified function, or block of code, does not return and
b) the said identified function, or block of code, does have nested functions which make a non-local-jumps to a parent function of the said identified function, or block of code, and
c) neither the said parent function, or block of code, nor none of its return-reachable parent functions, or blocks of code, check the canary value.

4. The method of claim 1, wherein:
a) the said identified function, or block of code, may return and
b) the said identified function, or block of code, does not check the canary value and
c) none of the return-reachable parent functions, or blocks of code, check the canary value.

5. The method of claim 1 comprising the renewing of the reference-canary wherein the said identified function, or block of code, is one of the initializing functions of a new thread or task or process (fork or clone or equivalent).

6. The method of claim 1 comprising the renewing of the reference-canary wherein the said identified function, or block of code, is a system call service routine.

7. The method of claim 1 comprising the renewing of the reference-canary wherein the said identified function, or block of code, is the main loop of a worker server.

8. The method of claim 1 comprising the renewing of the reference-canary wherein the said identified function, or block of code, which may be exposed to attacks:
a) functions that handle user accessible data or
b) functions that use libraries or code from non-trusted sources or
c) functions that start the execution or interpretation or emulation of code that is loaded as plugins.

9. The method of claim 1 comprising the renewing of the reference-canary wherein the said identified function, or block of code, which has exception handler code. Typically, functions that contain a “try-catch” block of code or save the stack context/environment for doing non-local-jumps.

10. A method for protecting the SSP technique on a program against leaking information regarding the value of the canary of the said SSP technique. The method consists on renewing and restoring the reference-canary at key places in the code while the program is running. The method comprising the steps of:
a) prior to the compilation, identify a function, or block of code, such that the already stacked frame-canaries are checked afterwards.
b) for each of said identified function, or block of code, it is possible to renew and restore the reference-canary. Comprising the steps of:
i. prior to renew the reference-canary, store the current reference-canary value into a designated location;
ii. compute a new random number;
iii. overwrite the reference-canary with the said new random number;
iv. before checking the canary value, the reference-canary must be restored, by copying the previously stored reference-canary value back to the reference-canary.

11. The method of claim 10, wherein:
a) the said identified function, or block of code, may return and
b) the said identified function, or block of code, checks the canary value.

12. The method of claim 10, wherein:
a) the said identified function, or block of code, may return and
b) the said identified function, or block of code, does not check the canary value and
c) at least one return-reachable parent function, or block of code, of the said identified function, or block or code, checks the canary value.

13. The method of claim 10, wherein:
a) the said identified function, or block of code, does not return and
b) the said identified function, or block of code, has at least a nested function which make a non-local-jump to a parent function of the said identified function, and
c) the said parent function, or block of code, or at least one of its return-reachable parent functions, or blocks of code, check the canary value.

14. The method of claim 10 comprising the renewing of the reference-canary wherein the said identified function, or block of code, which has exception handler code. Typically, functions that contain a “try-catch” block of code or save the stack context/environment for doing non-local-jumps.

15. The method of claim 10 comprising the renewing of the reference-canary wherein the said identified function, or block of code, is the main loop of a worker server.

16. The method of claim 10 comprising the renewing of the reference-canary wherein the said identified function, or block of code, which may be exposed to attacks:
a) functions that handle user accessible data or
b) functions that use libraries or code from non-trusted sources or
c) functions that start the execution or interpretation or emulation of code that is loaded as plugins.
